(19) United States
(12) Patent Application Publication
(10) Pub. No.: US 2007/0047642 A1
(43) Pub. Date: Mar. 1, 2007

(54) Video data compression

(76) Inventor: Erik Erland Erlandson, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/217,634

(22) Filed: Aug. 31, 2005

(51) Int. Cl. H04N 11/04

(52) U.S. Cl. 375/240.01

(57) ABSTRACT

An image encoder includes a processor operable to receive pixel data representing a first image, identify a first visual object within the first image and a location of the first object within the first image, and generate data representing the first object and its location.

### BACKGROUND

To electronically transmit relatively high-resolution video images over a relatively low-bandwidth channel, or to electronically store video or still images in a relatively small memory space, it is often necessary to compress the digital data that represents the images. Such video image compression typically involves reducing the number of data bits necessary to represent an image.

Referring to FIGS. 1A-2, the basics of the Moving Pictures Experts Group (MPEG) compression standards, which include MPEG-1-MPEG-4, are discussed. The MPEG standards are block-based compression formats that divide a video image into blocks and that then utilize discrete cosine transform (DCT) compression to sample the image at regular intervals, analyze the frequency components present in each sample, and discard those frequencies that do not affect the human eye's perception of the image. For purposes of illustration, the discussion is based on using an MPEG-2 4:2:0 format to compress video images represented in a Y, C_{B}, C_{R} color space.

Referring to FIG. 1A, each video image, or frame, is divided into subregions called macro blocks, which each include one or more pixels. FIG. 1A is a 16-pixel-by-16-pixel macro block 10 having 256 pixels 12 (not drawn to scale). In the MPEG-2 standard, a macro block is 16×16 pixels, although other compression standards may use macro blocks having other dimensions. In the original video frame, i.e., the frame before compression, each pixel 12 has a respective luminance value Y and a respective pair of chroma-difference values C_{B} and C_{R}.

Referring to FIGS. 1A-1D, before compression of the frame, the digital luminance (Y) and chroma-difference (C_{B} and C_{R}) values that will be used for compression are generated from the original Y, C_{B} and C_{R} values of the original frame. In the MPEG-2 4:2:0 format, the pre-compression Y values are the same as the original Y values. Thus, each pixel 12 merely retains its original luminance value Y. But to reduce the amount of data to be compressed, the MPEG-2 4:2:0 format allows only one pre-compression C_{B} value and one pre-compression C_{R} value for each group 14 of four pixels 12. Each of these pre-compression C_{B} and C_{R} values are respectively derived from the original C_{B} and C_{R} values of the four pixels 12 in the respective group 14. For example, a pre-compression C_{B} value may equal the average of the original C_{B} values of the four pixels 12 in the respective group 14. Thus, referring to FIGS. 1B-1D, the pre-compression Y, C_{B} and C_{R} values generated for the macro block 10 are arranged as one 16×16 matrix 16 of pre-compression Y values, one 8×8 matrix 18 of pre-compression C_{B} values, and one 8×8 matrix 20 of pre-compression C_{R} values. The matrices 16, 18 and 20 are often called “blocks” of values. Furthermore, because it is convenient to perform the compression transforms on 8×8 blocks of pixel values instead of on 16×16 blocks, the block 16 of pre-compression Y values is subdivided into four 8×8 blocks 22a-22d, which respectively correspond to the 8×8 blocks A-D of pixels in the macro block 10. Thus, referring to FIGS. 1A-1D, six 8×8 blocks of pre-compression pixel data are generated for each macro block 10: four 8×8 blocks 22a-22d of pre-compression Y values, one 8×8 block 18 of pre-compression C_{B} values, and one 8×8 block 20 of pre-compression C_{R} values.

An MPEG compressor, or encoder, converts the pre-compression data for a frame or sequence of frames into encoded data that represent the same frame or frames with significantly fewer data bits than the pre-compression data. To perform this conversion, the encoder reduces redundancies in the pre-compression data and reformats the remaining data using DCT and coding techniques.

More specifically, the encoder receives the pre-compression data for a sequence of one or more frames and reorders the frames in an appropriate sequence for encoding. Thus, the reordered sequence is often different than the sequence in which the frames are generated and will be displayed. The encoder assigns each of the stored frames to a respective group, called a Group Of Pictures (GOP), and labels each frame as either an intra (I) frame or a non-intra (non-I) frame. The encoder always encodes an I frame without reference to another frame, but can and often does encode a non-I frame with reference to one or more of the other frames in the same GOP. If an I frame is used as a reference for one or more non-I frames in the GOP, then the I frame is encoded as a reference frame.

During the encoding of a non-I frame, the encoder initially encodes each macro block of the non-I frame in at least two ways: in the same manner as for I frames, or using motion prediction, which is discussed below. This technique ensures that the macro blocks of the non-I frames are encoded using the fewest number of bits possible with the available coding schemes.

With respect to motion prediction, a macro block of pixels in a frame exhibits motion if its relative position changes in the preceding or succeeding frames. Generally, succeeding frames contain at least some of the same macro blocks as the preceding frames. But such matching macro blocks in a succeeding frame often occupy respective frame locations that are different than the respective frame locations that they occupy in the preceding frames. Alternatively, a macro block may occupy the same frame location in each of a succession of frames, and thus exhibit “zero motion.” In either case, instead of encoding each frame independently, it often takes fewer data bits to tell a decoder “the macro blocks R and Z of frame 1 (non-I frame) are the same as the macro blocks that are in locations S and T, respectively, of frame 0 (reference frame).” This “statement” is encoded as a motion vector.

FIG. 2 illustrates the concept of motion vectors with reference to the non-I frame 1 and the reference frame 0 as discussed above. A motion vector MV_{R} indicates that a match for the macro block in the location R of frame 1 can be found in the location S of the reference frame 0. MV_{R} has three components. The first component, here 0, indicates the frame (here frame 0) in which the matching macro block can be found. The next two components, X_{R} and Y_{R}, together comprise the two-dimensional location value that indicates where in the frame 0 the matching macro block is located. Thus, in this example, because the location S of the frame 0 has the same X-Y coordinates as the location R in the frame 1, X_{R}=Y_{R}=0. Conversely, the macro block in the location T matches the macro block in the location Z, which has different X-Y coordinates than the location T. Therefore, X_{Z} and Y_{Z} represent the location T with respect to the location Z. For example, suppose that the location T is ten pixels to the left of (negative X direction) and two pixels down from (negative Y direction) the location Z. Therefore, MV_{Z}=(0, −10, −2). Although there are many other motion vector schemes available, they are all based on the same general concept.

Unfortunately, although MPEG formats and other block-based encoding techniques are capable of high compression rates with an acceptable loss of image quality, many of these techniques have inherent limitations that prevent them from achieving even greater compression rates for image storage and video transmission. For example, because block-based encoding techniques divide all video images into macro blocks, these techniques typically are not only limited to making decisions one macro block at a time, but they may also be limited to compressing data one macro block at a time.

### SUMMARY

An embodiment of the present invention is an image encoder including a processor operable to receive pixel data representing a first image, to identify a visual object and a location of the object within the first image, and to generate data representing the object and its location.

By implementing an object-based compression instead of a block-based compression, such an image encoder may achieve a higher compression ratio than a block-based encoder, particularly where the object is larger than a macro block.

### BRIEF DESCRIPTION OF THE DRAWINGS

FIG. 1A is a diagram of a macro block of pixels in an image according to a conventional block-based compression standard.

FIG. 1B is a diagram of a block of pre-compression luminance values that respectively correspond to the pixels in the macro block of FIG. 1A according to a conventional block-based compression standard.

FIGS. 1C and 1D are diagrams of blocks of pre-compression chroma values that respectively correspond to the pixel groups in the macro block of FIG. 1A according to a conventional block-based compression standard.

FIG. 2 illustrates the concept of motion vectors according to a conventional block-based compression standard.

FIG. 3 illustrates the concept of using image objects for motion prediction according to an embodiment of the invention.

FIG. 4 illustrates the concept of patterns of motion for image objects according to an embodiment of the invention.

FIG. 5 illustrates the concept of panoramic frames according to an embodiment of the invention.

FIG. 6 illustrates the concept of scene repetition according to an embodiment of the invention.

FIG. 7 is a block diagram of a system that includes an image encoder and decoder according to an embodiment of the invention.

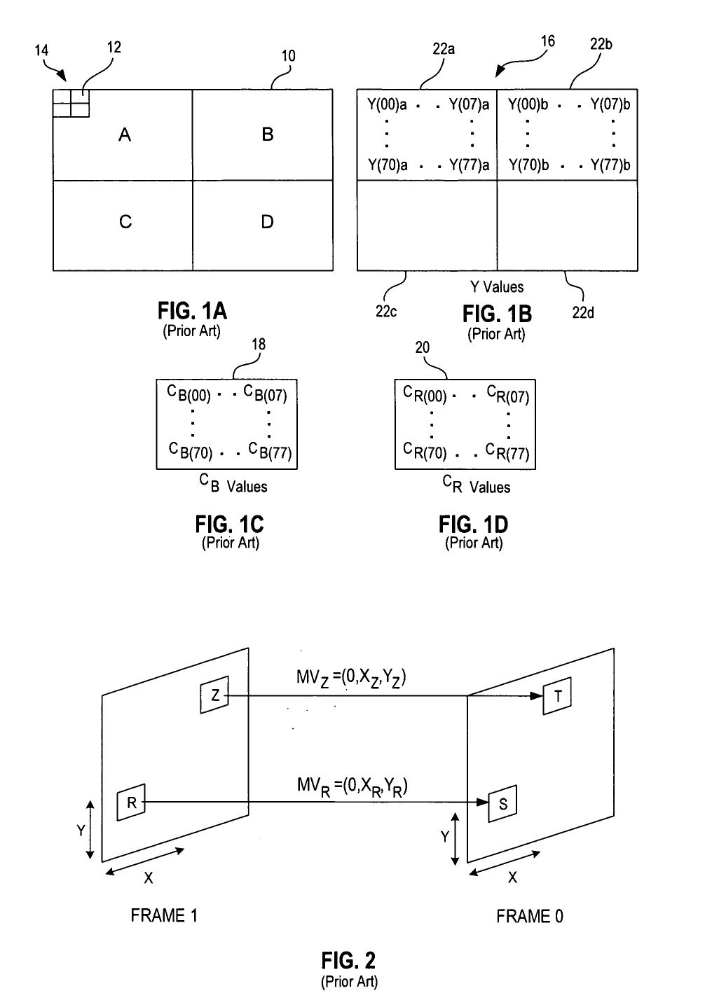

### DETAILED DESCRIPTION

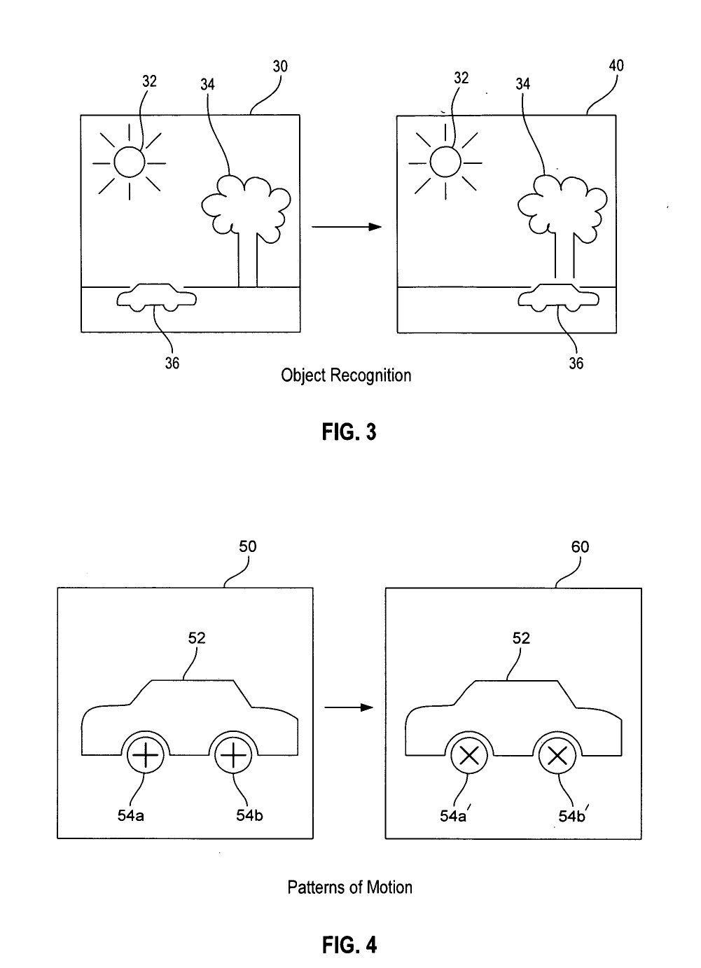

FIG. 3 illustrates the concept of using image objects for motion prediction according to an embodiment of the invention. For purposes of illustration, the example discussed below is based on an MPEG image encoder/transmitter (not shown in FIG. 3) that captures, compresses, and transmits pixel data that represents a video image 30. However, the encoder/transmitter may utilize a type of conventional compression format other than MPEG, or no conventional compression algorithm at all.

After capturing a first frame of pixel data representing a first video image 30, the encoder/transmitter uses optical character recognition (OCR) or another conventional algorithm to identify the following visual objects within the image 30: a sun 32, a tree 34, and an automobile 36. For example, the object-identifying algorithm may detect the edges of an object by recognizing contrast changes within the image. In this way the encoder/transmitter is able to identify the above-listed objects by detecting the edges or the edge contours of the sun 32, the tree 34 and the automobile 36.

Once the objects 32, 34, 36 have been detected, the encoder/transmitter stores data representing the shape and pixel content of each object in an object buffer (not shown in FIG. 3). The encoder/transmitter also generates data corresponding to each object, including data that represents the orientation of the object and the location of the object within the image. Such data may include the two-dimensional coordinates of the object within the image, and a rotational orientation vector. Although the number of stored objects may be limited by the memory capacity of the object buffer, each object may be given a priority based on how frequently and how recently the object has been identified in one or more images. That way, when the memory capacity of the object buffer is exceeded, the object with the least priority is deleted to make room for a new object.

After storing the data representing the shape and pixel content of the objects 32, 34, 36 in the object buffer, the encoder/transmitter encodes the entire image 30 in a standard MPEG format to create a reference frame, and sends the encoded reference frame to a decoder/receiver (not shown in FIG. 3). In addition, the encoder/transmitter also sends the shape, orientation, and location data corresponding to the objects 32, 34, 36 to the decoder/receiver. The encoder/transmitter may or may not encode the orientation and location data.

The decoder/receiver then decodes the reference frame to recover the pixels that compose a decoded version of the image 30, and stores these pixels in a reference-frame buffer (not shown in FIG. 3). The decoder/receiver then stores the received shape, orientation, and location data corresponding to the objects 32, 34, 36 in a decoder/receiver object buffer (not shown in FIG. 3).

Next, the encoder/transmitter captures a second frame of pixel data representing a second image 40, and again uses the object-identifier algorithm to identify the visual objects 32, 34, 36 within the image 40. The second image 40 may be the next image captured after the image 30, or may be more than one image subsequent to the image 30. The transmitter compares the detected objects within the second image 40 with the objects already stored in the object buffer. If there is no match and the second image 40 is also a reference image, then data corresponding to each new object is stored in the encoder/transmitter object buffer. But in this example, the objects 32, 34, 36 within the image 40 match the same objects 32, 34, 36 within the image 30. Because data (e.g., content and shape data) that defines the objects 32, 34, 36 are already stored in the object buffer, the encoder/transmitter does not need to again store this data for the objects 32, 34, 36.

The encoder/transmitter also compares the data corresponding to the objects 32, 34, 36 in the image 40 with the stored data corresponding to the same objects in the image 30. For example, because the locations of the sun 32 and the tree 34 have not changed between the images 30 and 40, the encoder/transmitter determines that the sun 32 and the tree 34 are stationary objects. However, because the location of the automobile 36 has changed between the images 30 and 40, the encoder/transmitter determines that the automobile 36 is a moving object and sends a motion vector associated with the automobile 36 to the decoder/receiver. This allows the decoder/receiver to “know” the new position of the automobile 36 within the image 40.

In this way, the encoder/transmitter does not have to re-send the objects 32, 34, 36 to the decoder/receiver. The encoder/transmitter only needs to send the location and orientation data of the objects 32, 34, 36 to the decoder/receiver because the decoder/receiver already has these objects stored in its frame buffer. When the image 40 is encoded, the encoder/transmitter does not encode the objects 32, 34, 36 but only encodes the remaining portion of the image 40. In the portions of the image 40 where the objects 32, 34, 36 are located, the encoder/transmitter simply sends an object identifier, the object's orientation, and the object's location (which may be in the form of a motion vector) to the decoder/receiver, thus significantly reducing the amount of transmission data and possibly reducing the bandwidth needed between the encoder/transmitter and the decoder/receiver.

The decoder/receiver then receives and decodes the encoded portion of the image 40. Because the objects 32, 34, 36 are already stored in the decoder/receiver's frame buffer, the decoder/receiver retrieves the objects 32, 34, 36 from its frame buffer and inserts them in their respective locations within the decoded image 40 as indicated by the respective identifier, orientation, and location vectors sent by the encoder/transmitter. This is similar to the concept of motion vectors with macro blocks, but here it is done on a much larger scale because each object typically includes, or is equivalent in size to, multiple macro blocks. Furthermore, because each object is stored in an object buffer, the objects are not dependent on a GOP structure. That is, according to the MPEG standard, an I (reference) frame typically corresponds to only one GOP, which includes, for example, fifteen frames. Therefore, even if the scene exhibits little change over a GOP, the encoder/transmitter must re-send at least one new I frame for each GOP. In contrast, because the decoder/receiver stores an object in an object buffer, the encoder/transmitter need only transmit the object once. An exception to this is when the decoder/receiver's object buffer is full so that the decoder/receiver deletes a stored object to make room for a new object.

Alternatively, the encoder/transmitter and the decoder/receiver may use the location and orientation data corresponding to each object to eliminate the use of motion vectors altogether. Whenever the encoder/transmitter captures a frame of pixel data representing an image, instead of comparing the location and orientation of each object in the current image to the location and orientation of the same objects in the previous image to determine a motion vector, the encoder/transmitter may simply send the location and orientation data of each object to the decoder/receiver for every image. The decoder/receiver may then use the location and orientation data of each object to insert the object from the object buffer into the appropriate location for every image without having to reference a previous location or orientation of the object.

Still referring to FIG. 3, the content data corresponding to each object may be used by the encoder/transmitter and the decoder/receiver to take into account differences in content of an object from image to image. The encoder/transmitter may determine slight differences in an object from image to image, and encode these differences as residuals on a per block basis within the object, or in some other manner. In this way, the encoder/transmitter only needs to send the residuals to the decoder/receiver instead of the entire object. Then the decoder/receiver decodes the residuals and applies them to the objects retrieved from the decoder/receiver's object buffer. For example, the automobile 36 in the image 40 may have slightly different reflections and shadows than it has in the image 30. These differences in the content of the automobile 36 may be encoded by the encoder/transmitter as residuals and sent to the decoder/receiver. The decoder/receiver then decodes the residuals, retrieves the automobile 36 from the decoder/receiver's object buffer, and uses the residuals to modify the corresponding portions of the automobile 36 that are different in the image 40.

Also, the content data corresponding to an object may be used by the encoder/transmitter and the decoder/receiver to update the object from image to image. The encoder/transmitter may determine that new portions are being added to an object from image to image, and thus add the new portions to the object and store the updated object in the object buffer. The encoder/transmitter then encodes these new portions on a per block basis, or in some other manner. In this way, the encoder/transmitter only needs to send the new portions of the object to the decoder/receiver instead of the entire object. Then the decoder/receiver decodes the new portions of the object, adds them to the object retrieved from the decoder/receiver's object buffer, and stores the updated object in the object buffer. For example, the automobile 36 may be entering an image from left to right. Suppose in the image 30, only the front bumper of the automobile 36 is visible at the left edge of the image. As the automobile 36 moves from left to right, more of the automobile 36 becomes visible in the image 40. These new portions (e.g., the front wheel and the hood) of the automobile 36 are added to the bumper, and the updated automobile 36 is stored in the encoder/transmitter's object buffer. These new portions of the automobile 36 are also encoded by the encoder/transmitter and sent to the decoder/receiver. The decoder/receiver then decodes the new portions, retrieves the bumper of the automobile 36 from the decoder/receiver's object buffer, adds the new portions to the bumper, and stores the updated automobile 36 in the decoder/receiver's object buffer.

In addition, the encoder/transmitter may divide a larger object into sub-objects or object sections. This may be advantageous if one of the object sections changes from image to image more frequently than the other object sections. In this way, the encoder/transmitter can limit the encoding and transmission of object data to only the object section that changes instead of to the entire object. For example, instead of treating the automobile 36 as a single object, the encoder/transmitter may treat the bumper, the wheels, the doors, etc. of the automobile as separate objects. Or, the encoder/transmitter may treat the bumper, the wheels, the doors, etc. as sub-objects of the automobile object.

Still referring to FIG. 3, the embodiment described above is useful for a scene having a relatively stable depth of field, i.e., where the focal length and aperture of the camera stays relatively stable. This is because telephoto or wide-angle effects, such as zooming in and out, may result in blooming or shrinking of the image and the objects therein. This may cause the objects of the image to change in size and detail, and thus cause the encoder/transmitter to not recognize an object from one frame to the next. One solution to this problem is to store the image in multiple layers, where each layer of the image corresponds to a different focal length and/or f-stop. Then the object-identifying algorithms may be applied to each image layer.

FIG. 4 illustrates the concept of patterns of motion for image objects according to an embodiment of the invention. In some images, an object may exhibit relative motion relative to the image or the object itself. This can also be characterized as a change in the orientation of the object or of a portion of the object. The encoder/transmitter and the decoder/receiver may use the orientation data corresponding to each object to take into account changes in the object's (or object portion's) orientation from image to image.

For example, after detecting an automobile 52 and wheels 54a and 54b in a third image 50, the encoder/transmitter stores each object and its orientation data in the encoder/transmitter's object buffer-here, the encoder/transmitter stores the automobile 52, the wheel 54a, and the wheel 54b as separate objects. The orientation data of each object may include a location and/or orientation vector, or any other indicator of orientation within the image. The encoder/transmitter encodes the automobile 52 and the wheels 54, and sends the encoded objects and their location and orientation data to the decoder/receiver. The decoder/receiver then decodes the automobile 52 and the wheels 54 from the encoded image 50, and stores the objects and their location and orientation data in the decoder/receiver's object buffer.

When the encoder/transmitter detects the automobile 52 and the wheels 54a′ and 54b′ in a fourth image 60, the encoder/transmitter compares the orientation data of the objects in the fourth image 60 to the orientation data of the objects already stored in the encoder/transmitter's memory buffer from the third image 50. In this example, neither the location nor the orientation of the automobile 52 has changed between the images 50 and 60. Similarly, the locations of the wheels 54 and 54′ have not changed between the images 50 and 60. However, because the wheels 54 and 54′ have undergone a rotation between the images 50 and 60, the orientations of the wheels 54 have changed. As a result, the encoder/transmitter stores the wheels 54a′ and 54b′ and their new orientations in the object buffer, encodes the wheels 54a′ and 54b′ (along with the rest of the image minus previously encoded objects), and sends the encoded wheels 54a′ and 54b′ and their orientation data to the decoder/receiver. The decoder/receiver then decodes the wheels 54a′ and 54b′ and stores them and their orientation data in the decoder/receiver's object buffer.

This process is repeated for every subsequent image in which the wheels 54′ undergo a further change in orientation, until a pattern of motion is detected by the decoder/transmitter. In this example, when the encoder/transmitter again detects the same or similar orientation that the wheels 54 have in the third image 50, the pattern of motion is complete because the wheels 54a and 54b have completed one full rotation. When this occurs, the encoder/transmitter no longer needs to store, encode and transmit an entirely new wheel for every image. Instead, the encoder/transmitter only needs to send a signal instructing the decoder/receiver to repeat the sequence of the wheels, corresponding to the wheels' rotation, already stored in the decoder/receiver's object buffer. This signal may simply be an orientation vector that tells the decoder/receiver the rotational orientations of the wheels, and thus which versions of the wheels to display in that particular image. In addition, the rotational sequences of the wheels 54a and 54b, or any other pattern of motion, may be stored as a motion algorithm in the decoder/receiver's object buffer or in an algorithm buffer. Such a motion algorithm may automatically calculate the correct orientation of the wheels 54a and 54b for each image thereafter. That is, instead of the encoder/transmitter continuing to send orientation data for the wheels 54a and 54b, the decoder/receiver merely “rotates” the wheels from image to image by sequencing through the previously stored orientations of the wheels until the automobile 52 leaves the scene.

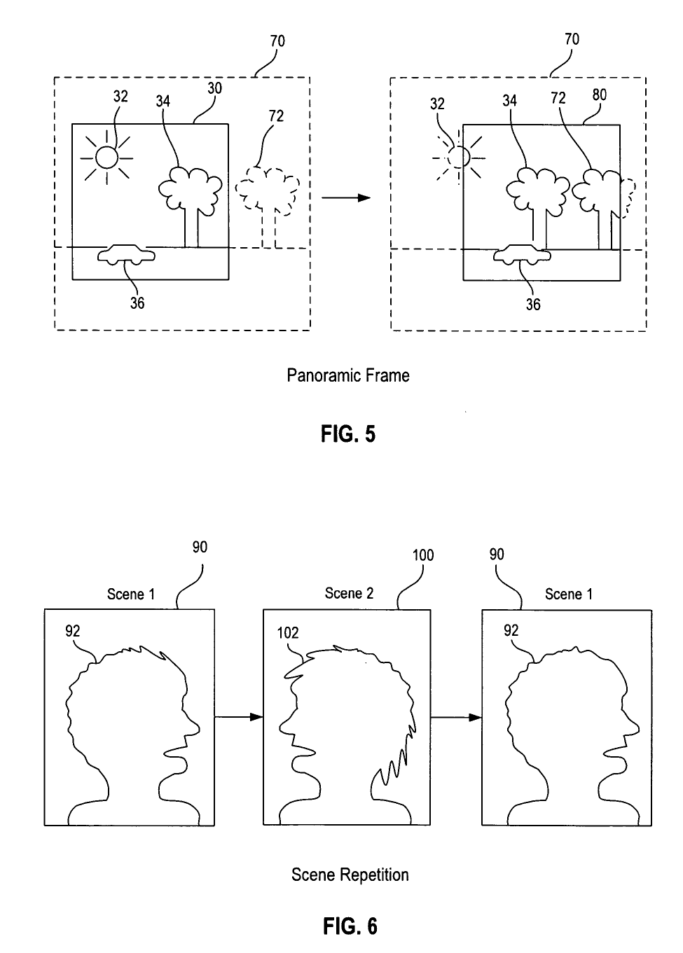

FIG. 5 illustrates the concept of panoramic frames according to an embodiment of the invention. Generally, a panoramic frame, or super frame, is a scene with dimensions greater than a viewable frame or image that is actually displayed by the decoder/receiver. Because the boundaries of the panoramic frame extend beyond the boundaries of the viewable image, the viewable image can be thought of as a “window” within the panoramic frame. As a result, minor panning of the camera is equivalent to movement of the “window” within the panoramic frame.

For example, the background (i.e., non-object image content such as the sky and the ground) of a panoramic frame 70 may be stored in respective background buffers in both the encoder/transmitter and the decoder/receiver. Although the viewable image 30 in FIG. 5 is similar to the image 30 in FIG. 3, the viewable image 30 in FIG. 5 is a viewable portion of the larger panoramic frame 70. Because the background of the viewable image 30 is already stored in the encoder/transmitter's background buffer as a portion of the panoramic frame 70, the encoder/transmitter does not need to re-send the entire background of the viewable image 30 to the decoder/receiver. Instead, the encoder/transmitter only needs to send a location of the viewable image 30 within the panoramic frame 70 to the decoder/receiver, and any changes within the panoramic frame 70, such as movement of the automobile 36 as discussed below. Then the decoder/receiver may use the location data to retrieve from its background buffer the portion of the panoramic frame 70 coinciding with the viewable image 30.

The objects 32, 34, 36, 72 in the viewable image 30 in FIG. 5 may be treated similarly as the objects 32, 34, 36 in FIG. 3. As discussed above, the encoder/transmitter uses an algorithm to detect and identify the objects 32, 34, 36 within the viewable image 30, and compares these objects to the objects stored in the encoder/transmitter's object buffer. In this example, because the background of the panoramic frame 70 has already been stored in the encoder/transmitter's background buffer, each of the objects 32, 34, 36, 72 have similarly been stored in the encoder/transmitter's object buffer. As a result, the transmitter only needs to send the locations and orientations of the objects 32, 34, 36, 72 to the decoder/receiver. Then the decoder/receiver may use the location data to retrieve the objects 32, 34, 36, 72 from its object buffer, and insert the objects at the appropriate locations within the viewable image 30.

Alternatively, the stationary objects 32, 34, 72 may be stored as part of the background of the panoramic frame 70 itself, and thus be included in the background of the viewable images. In this way, the encoder/transmitter only needs to identify the moving objects (such as the automobile 36) separately from the background of the viewable image, and send the locations and orientations of the moving objects to the decoder/receiver.

Still referring to FIG. 5, when the encoder/transmitter captures a second viewable image 80, the encoder/transmitter compares the viewable image 80 to the panoramic frame 70 stored in the encoder/transmitter's background buffer. Because the background of the viewable image 80 matches a portion of the panoramic frame 70, the encoder/transmitter does not need to re-send the entire background data of the viewable image to the decoder/receiver. As a result, even though the backgrounds of the viewable images 30, 80 are different, and thus represent movement of the camera, the encoder/transmitter only needs to send to the decoder/receiver the location of the viewable image 80 within the panoramic frame 70. The decoder/receiver may then use the new location data to retrieve from its background buffer the portion of the panoramic frame 70 corresponding to the background of the viewable image 80.

Again, each of the objects 32, 34, 36, 72 may already be stored in the object buffers of the encoder/transmitter and the decoder/receiver. However, because only a portion of the sun 32 and the tree 72 are visible in the viewable image 80, the encoder/transmitter may not recognize these objects and instead store them as new objects in the object buffer. In this case, the encoder/transmitter sends to the decoder/receiver these visible portions of the sun 32 and the tree 72 as new objects in addition to the locations of the tree 34 and the automobile 36.

Alternatively, if the stationary objects 32, 34, 72 are stored as part of the background of the panoramic frame 70 itself, then the portions of the sun 32 and the tree 72 are simply treated as part of the background of the viewable image 80. As a result, the encoder/transmitter only needs to send to the decoder/receiver the new location of the automobile 36.

The panoramic frame 70 may be generated when an image-capture device (e.g., a camera) captures a series of images (e.g., image 30) as the camera pans around. The encoder/transmitter then “builds” and updates the panoramic frame 70 from these images, and also sends the panoramic frame 70 and updates thereto to the decoder/receiver. Thus, after the panoramic frame 70 is generated, by sending only the updated portions of the panoramic frame 70 to the decoder/receiver as each new image 30 or 80 is captured, the amount of transmitted data is significantly reduced.

More specifically, the camera coupled to the encoder/transmitter captures an image such as the image 30 or 80 and stores the image in the encoder/transmitter's background buffer. The encoder/transmitter then sends the image to the decoder/receiver where the frame 70 is also stored in the decoder/receiver's background buffer. As the camera continues to capture subsequent images, if a portion of the captured image matches a portion of the stored frame but also includes new background portions not found in the frame, then the encoder/transmitter adds the new background portions to the frame, i.e., updates the frame 70. In this way, the content of the panoramic frame 70 may change as a function of the camera movement. The encoder/transmitter then sends only the new portions of the panoramic frame 70 to the decoder/receiver to update the panoramic frame already stored in the decoder/receiver's background buffer.

Although the size and dimensions of the panoramic frame 70 may be limited by the memory capacity of the background buffers in the encoder/transmitter and the decoder/receiver, certain portions of the frame 70 may be higher in priority than other portions of the frame based on how recently the portions have been identified or on their position relative to the most recently identified portions. That way, if the memory capacity of the background buffer is exceeded, then the portions of the frame 70 with the least priority are deleted to make room for the most recently added portions of the frame. For example, if the camera pans right, past the right edge of the stored frame 70, then the entire frame 70 may be shifted to the left in the background buffer to make room for the new right portion of the frame. Alternatively, instead of shifting the entire frame 70 in the background buffer, the background buffer may incorporate a “wrap around effect.” For example, if the camera pans beyond the right edge of the stored frame 70, these new frame portions are stored as entering from the left side of the frame 70. Therefore, only a portion of the background buffer (corresponding to the left side of the frame 70) is overwritten, instead of having to shift data.

Still referring to FIG. 5, for any given panoramic frame, one or more reference points may be chosen to indicate the position of the camera relative to the panoramic frame 70. Such a reference point allows the encoder/transmitter to measure the movement and direction of the camera as it pans within the panoramic frame. For example, the camera panning to the right within the panoramic frame would cause the reference point to appear to pan to the left. In this way, the reference point positions may be used not only to determine the position of the camera at any given point, but also to anticipate where the camera is going. The decoder/receiver may then use this information to display the proper “window” (i.e., image 30 and image 80) position within the panoramic frame 70, and update the “window” position based on the movement of the camera.

The reference points themselves may be any relatively stationary object or icon within the panoramic frame. For example, these reference objects may be selected for their contrast and maintenance of visibility to the camera so that the camera system is able to identify the reference objects in a given scene. Objects that reoccur in a given scene may also be downloaded and stored in memory in advance so that the camera or encoder/transmitter may automatically identify the objects as reference points if a match is made in the image.

Alternatively, the reference points may also be invisible. For example, radio-frequency (RF) positioning devices may be located in the background of a scene. These RF devices may be hidden from view, and only detectible by the camera or encoder/transmitter system. The system may then capture images of the scene while recording position data from the RF devices.

Still referring to FIG. 5, a panoramic frame 70 may be particularly useful in a remote video game environment, where players use different game consoles that communicate, for example, over the internet. For example, a video game might have a single background scene, “windows” of which are displayed at different times during the game. In this case, the entire background scene may be stored as the panoramic frame 70, and every “screen shot” during the game may be a viewable “window” within the panoramic frame. In addition, if the video game utilizes a predetermined library of objects and characters, then the library of objects and characters may be stored in the console's object buffer before the game begins. In this way, one game console need not send to any of the other consoles the objects and characters used in the game. Instead, the transmitting console may send an object identifier to the receiving consoles so that the receiving consoles may retrieve the corresponding object from the library stored in their object buffers. As a result, throughout the game, the transmitting console may only need to send to the receiving consoles the locations of the viewable images within the panoramic frame, the object identifiers, and the locations and orientations of the objects. This can significantly reduce the amount of data transmitted between the consoles.

FIG. 6 illustrates the concept of scene repetition (i.e., switching back and forth between the same scenes) according to an embodiment of the invention. Many video sequences involve a repetition of multiple scenes or background images. Moreover, instead of the same scene being repeated consecutively, a pattern of different scenes may be repeated, or the same scene may be alternated with different scenes.

For example, a repetition of a dual scene may be when two people 92 and 102 are speaking to each other and the camera angle switches back and forth between the two images 90 and 100 that respectively include the people, where each image has a different background. After the image-capture device coupled to the encoder/transmitter captures the image 90 and then the image 100 for the first time, the backgrounds of both images are stored in a background buffer in both the encoder/transmitter and the decoder/receiver. In addition, the encoder/transmitter treats the people 92 and 102 as objects, which are detected and stored in object buffers in both the encoder/transmitter and the decoder/receiver.

When the image-capture device captures the image 90 for the second time, the encoder/transmitter compares the background of the image 90 to the backgrounds stored in the encoder/transmitter's background buffer. Because the background of the image 90 matches the same background already saved from the first time the encoder/transmitter captured the image 90, the encoder/transmitter recognizes that the image 90 has been repeated and does not need to re-send the entire background of the image to the decoder/receiver. As a result, even though the backgrounds of the images 100 and 90 are different and represent a change between entirely different scenes, the encoder/transmitter only needs to indicate to the decoder/receiver that a previous background is being repeated. The encoder/transmitter may also compare the object 92 in the image 90 to the objects stored in the encoder/transmitter's object buffer. This is particularly useful when the people 92 and 102 take up a majority of the images 90 and 100. In this case, because the object 92 matches the same object already saved from the first time the encoder/transmitter captured the image 90, the encoder/transmitter recognizes that the image 90 has been repeated and does not need to re-send the entire object 92 to the decoder/receiver. In addition, whether the encoder/transmitter is comparing backgrounds or objects, the encoder/transmitter may utilize residuals as described above to account for small differences in content of the backgrounds and objects. Furthermore, the encoder/transmitter may treat stationary parts of the objects 92 and 102 as background or as unique objects, and the moving parts, such as a person's mouth as he speaks, as separate objects as discussed above in conjunction with FIG. 3.

Alternatively, instead of the encoder/transmitter saving the backgrounds of the images 90 and 100 as separate backgrounds, the encoder/transmitter may combine the backgrounds into a single panoramic frame. For example, the backgrounds of the images 90 and 100 may be treated as different viewable images within the same panoramic frame, this concept being discussed above in conjunction with FIG. 5. In this case, no matter how many times the backgrounds of the images 90 and 100 are repeated, the encoder/transmitter only needs to send the location of one of two viewable images within the same panoramic frame.

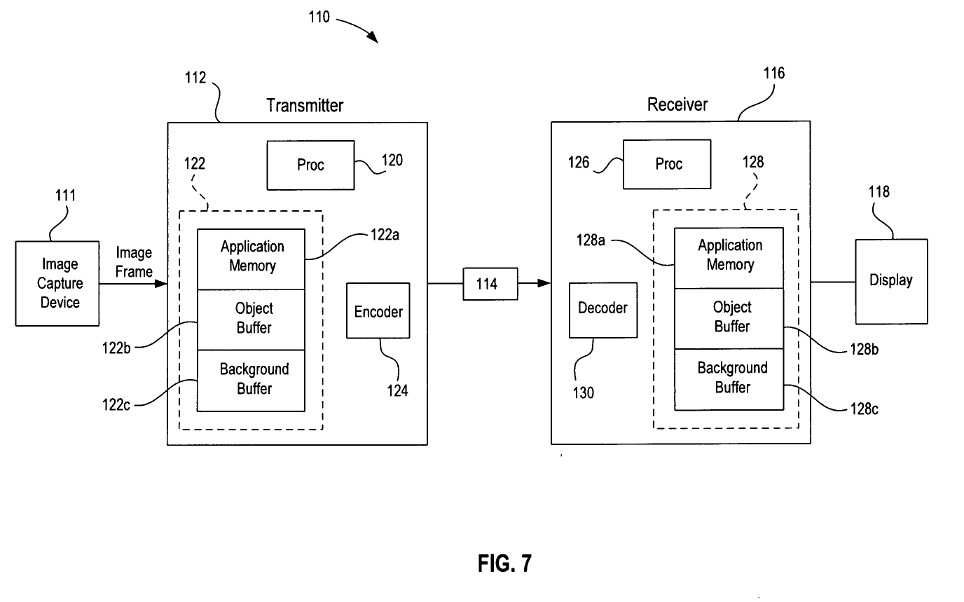

FIG. 7 is a block diagram of an image transmitter/receiver system 110 that can implement the concepts discussed above in conjunction with FIGS. 3-6 according to an embodiment of the invention. The system 110 includes an image-capture device 111, a transmitter 112, a network 114, a receiver 116, and an optional display 118.

The image-capture device 111 is coupled to the transmitter 112, and provides captured images to the transmitter 112. The image-capture device 111 may be a camera or any other image source.

The transmitter 112 includes a processor 120, a memory 122, and an optional encoder 124. The transmitter 112 receives images the image-capture device 111. Then the processor 120 processes the image according to one or more of the concepts described above in conjunction with FIGS. 3-6. The software applications executed by the processor 120 are stored in an application memory 122a. The memory 122 may also include one or more memory buffers 122b and 122c, such as object or background buffers. The memory 122 may be any type of digital storage. For example, the memory 122 may include semiconductor memory, magnetic storage, optical storage, or solid-state storage.

Because some objects may appear in front of others in an image, the objects in the image may be organized by priority. As a result, the transmitter 112 may have multiple memory buffers, where the memory buffers have a hierarchy. For example, the transmitter 112 may have two memory buffers, where one of the memory buffers 122b is used as an object buffer for, e.g., the tree 34 and the automobile 36 of FIG. 5, and the other memory buffer 122c is used to store background information for, e.g., a panoramic view such as the view 70 of FIG. 5. In this case, the objects in the object buffer 122b have a higher priority than the background information in the background buffer 122c so that the objects always appear in front of the background in the images. Alternatively, the transmitter 112 may have multiple object buffers and multiple background buffers, so that each image is divided into multiple layers of objects (e.g., when the automobile 36 passes in front of the tree 34) and multiple layers of backgrounds. In this case, the priority of an object or background layer depends on its relative position along the virtual z-axis of the image. The virtual z-axis in a two-dimensional image represents a perceived depth in the image.

The transmitter 112 may also include an encoder 124 for encoding the images prior to transmitting the images to the receiver 116. The encoder 124 may utilize any type of video compression format, including an MPEG format similar to that described above. Alternatively, the transmitter 112 may not include any encoder at all if no compression format is utilized.

The transmitter 112 then sends the image data to the receiver 116 through the network 114. The network 114 may be any type of data connection between the transmitter 112 and the receiver 116, including a cable, the internet, a wireless channel, or a satellite connection.

The receiver 116 includes a processor 126, a memory 128, and an optional decoder 130. The receiver 116 receives the image data transmitted by the transmitter 112, and operates together with the transmitter to reproduce the images captured by the image-capture device 111. As a result, the structure of the receiver 116 corresponds, in part, to the structure of the transmitter 112. For example, if the transmitter's memory 122 includes an application memory 122a, an object buffer 122b, and a background buffer 122c, then the receiver's memory 128 may also include an application memory 128a, an object buffer 128b, and a background buffer 128c. Similarly, if the transmitter's memory 122 includes multiple object buffers and multiple background buffers, then the receiver's memory 128 may include multiple object buffers and multiple background buffers. In addition, if the transmitter 112 includes an encoder 124 to encode the image data, then the receiver 116 includes a decoder 130 to decode the encoded image data from the transmitter.

The system 110 may also include a display 118 coupled to the receiver 116 for displaying the images. In this case, the receiver 116 may either be separate from the display 118 (as shown in FIG. 7) or the receiver may be built into the display. The display 118 may be any type of display, including a CRT monitor, a projection screen, an LCD screen, or a plasma screen.

From the foregoing it will be appreciated that, although specific embodiments of the invention have been described herein for purposes of illustration, various modifications may be made without deviating from the spirit and scope of the invention. For example, each of the described concepts may be used in combination with any of the other concepts when reproducing an image.

What is claimed is:

1. An image encoder, comprising:
a processor operable to,
receive pixel data representing a first image;
identify a first visual object within the first image and a location of the object within the first image; and
generate data representing the object and its location.

2. The image encoder of claim 1, wherein the processor is further operable to store the object in a memory buffer.

3. The image encoder of claim 1, wherein the processor is further operable to encode the object.

4. The image encoder of claim 1, wherein the processor is further operable to send the data representing the object and its location to a receiver.

5. The image encoder of claim 1, wherein the processor is further operable to:
receive pixel data representing a second image;
identify a second visual object within the second image and a location of the second object within the second image; and
compare the second object with the first object.

6. The image encoder of claim 5, wherein if the first and second objects are significantly similar, the processor is further operable to:
identify the first object as being the same as the second object; and
send an object identifier of the first object and the location of the second object to a receiver.

7. The image encoder of claim 5, wherein if the first and second objects are similar but not identical, the processor is further operable to:
generate a residual representing a difference in content between the first and second objects; and
send the residual and the location of the second object to a receiver.

8. The image encoder of claim 5, wherein if the first and second objects are significantly different, the processor is further operable to generate data representing the second object and its location.

9. The image encoder of claim 8, wherein the processor is further operable to store the second object in a memory buffer.

10. The image encoder of claim 5, wherein if the first and second objects are significantly similar, the processor is further operable to:
determine an orientation of the second object relative to the first object; and
send the location and the orientation of the second object to a receiver.

11. The image encoder of claim 1, wherein the processor is further operable to:
identify a sub-object within the first object; and
generate data representing the sub-object.

12. A receiver, comprising:
a processor operable to,
receive data representing a first visual object of a first image and a location of the object within the first image; and
store the first object in a memory buffer.

13. The receiver of claim 12, wherein the processor is further operable to decode the first object.

14. The receiver of claim 12, wherein the processor is further operable to receive a location of a second visual object within a second image.

15. The receiver of claim 14, wherein the processor is further operable to:
receive a residual representing a difference in content between the first and second objects; and
combine the residual with the data representing the first object to generate an updated first object.

16. The receiver of claim 14, wherein the processor is further operable to:
receive an orientation of the second object relative to the first object; and
combine the orientation with the data representing the first object to generate an updated first object.

17. The receiver of claim 12, wherein the processor is further operable to:
receive data representing a second visual object of a second image and a location of the second object within the second image; and
store the second object in the memory buffer.

18. The receiver of claim 12, wherein the processor is further operable to:
receive data representing a sub-object within the first object; and
store the sub-object in the memory buffer.

19. A system, comprising:
an image encoder having,
a processor operable to,
receive pixel data representing a first image;
identify a first visual object within the first image and a location of the first object; and
generate data representing the first object and its location.

20. A system, comprising:
a receiver having,
a processor operable to,
receive data representing a first visual object of a first image and a location of the first object within the first image; and
store the first object in a memory buffer.

21. The system of claim 20, further comprising a display coupled to the receiver.

22. A method, comprising:
identifying a first visual object within a first image and a location of the first object within the first image; and
generating data representing the first object and its location.

23. The method of claim 22, further comprising encoding the first object.

24. A method, comprising:
receiving data representing a first visual object of a first image and a location of the first object within the first image; and
storing the first object in a memory buffer.

25. The method of claim 24, further comprising decoding the first object.
